(19) United States
(12) Patent Application Publication
(10) Pub. No.: US 2014/0315060 A1
(43) Pub. Date: Oct. 23, 2014

(54) BATTERY SYSTEM AND METHOD OF PRODUCING AN ELECTRICALLY CONDUCTIVE CONNECTION BETWEEN A CELL CONNECTOR AND AN ELECTRONIC UNIT OF A BATTERY SYSTEM

(71) Applicant: MAGNA STEYR Battery Systems GmbH & Co OG, Zettling (AT)

(72) Inventors: David FAULAND, Gross St. Florian (AT); Thomas KROPSCH, Leoben (AT)

(73) Assignee: MAGNA STEYR Battery Systems GmbH & Co OG, Zettling (AT)

(21) Appl. No.: 14/251,125

(22) Filed: Apr. 11, 2014

(30) Foreign Application Priority Data
Apr. 17, 2013 (EP) 13164128.4

(51) Int. Cl. H01M 10/42; H01M 10/04; H01M 10/48

(52) U.S. Cl. CPC H01M 10/425; H01M 10/482; H01M 10/0413; H01M 2220/20
USPC 429/90; 29/623.1

(57) ABSTRACT

A battery system and a method for producing an electrically conductive connection. The battery system includes a plurality of cells that are arranged in at least in one stack, an electronic unit, and a conductor. First contact members arranged on the first contacting element are to at least one of penetrate insulation of the conductor at least in sections, and deform the conductor at least in sections. The conductor is configured for insertion into a first opening of a first contacting element and second openings of a second contacting element to establish contact with the first contact members. The first opening is configured to permit insertion of the first conductor section parallel to a base surface of the cell connector, and the second opening is configured to permit insertion of the second conductor section parallel to a base surface of the electronic unit.

### CROSS-REFERENCE TO RELATED APPLICATIONS

The present application claims priority 35 U.S.C. §119 to European Patent Publication No. EP 13164128.4 (filed on Apr. 17, 2013) which is hereby incorporated by reference in its entirety.

### TECHNICAL FIELD

Embodiments relate to a battery system and a method for producing an electrically conductive connection. The battery system includes a plurality of cells that are arranged in at least in one stack, an electronic unit, and a conductor. A first pole of a first cell is connected in an electrically conductive manner to a second pole of a second cell by way of a cell connector. The electronic unit is designed so as to detect the voltage of the cells. A first contacting element is arranged on the cell connector and a second contacting element is arranged on the electronic unit. A first section of the conductor is connected in an electrically conductive manner to the first contacting element and a second section of the conductor is connected in an electrically conductive manner to the second contacting element. The conductor is to make contact with the first contacting element and the second contacting element by way of first contact members arranged on the first contacting element and the second contacting element and are designed to penetrate the insulation of the conductor at least in sections and/or to deform the conductor at least in sections. The first contacting element includes a first opening and the second contacting element includes a second opening. The conductor may be inserted into the first opening and the second opening for the purpose of making contact with the first contact members.

### BACKGROUND

Battery systems of this type are used above all as energy storage devices in motor vehicles, by way of example, for driving electric vehicles and hybrid vehicles.

A battery system of the generic type is known from U.S. Patent Publication No. 2012/015550A1, which discloses a plurality of batteries arranged side by side and which are connected in series by way of a bus bar. A connector that comprises a wire is connected to the bus bar. The connector is provided with blades that are designed so as to cut through an insulating sleeve of the wire and to make pressure contact with the core of the wire. The wire leads to a voltage measuring device that is not described in further detail.

The Japanese Patent Publication No. JP 2011-049047A discloses a battery connection assembly having a plurality of connecting elements for electrically connecting adjacent electrode connectors. Each connecting element comprises an extension having a pressure contacting element that is in pressure contact with a voltage detection line. The voltage detection line leads to a control unit that comprises blades for contacting the voltage detection line.

The object of these publications is to achieve a high degree of automation during the process of assembling the battery system. An automated process of routing and contacting the cell voltage measuring lines is necessary in particular in the case of battery systems that comprise a large number of cells since it is only possible in this manner to achieve a safe and reliable assembly process. A manual process of routing and contacting the cell voltage measuring lines would be susceptible to incorrect routing and to inadequate contacts. It would be difficult to recognize any defects that may occur and this would result in a high degree of repair and restoration work. In order to be able to perform an automated routing and contacting process, easy access is required in particular to the contact sites where the cell voltage measuring lines are contacted.

In the hitherto known prior art, the contacting section of the cell voltage measuring line protrudes at the cell connector beyond the edge of the cell connector, and/or protrudes upwards perpendicularly from a base surface of the cell connector. As a consequence, although the contacting sections of the cell voltage measuring section of the cell voltage measuring line is easily accessible at the cell connector, the dimensions of the battery system are increased. This is undesirable since the installation space available in the vehicle for the battery system is limited. In addition, it is necessary during the process of contacting the cell voltage measuring line to ensure that the cells, which are connected to the cell connector, and also the electronic unit are not damaged as a result of mechanical loads during the contacting process. Both the electronic unit and also the cells may be damaged as a result of pressure loads, or also earlier damage may go unnoticed. Any earlier damage that is initially unnoticed may lead to subsequent mechanical failure.

### SUMMARY

Embodiments relate to enhanced battery systems of the mentioned type in which it is possible to perform an automated process of routing and contacting the cell voltage measuring lines for an assembly process that is safe and reliable whilst simultaneously maintaining small dimensions of the battery system and low mechanical loads on the cells and the electronic unit.

Embodiments relate to a method for producing an electrically conductive connection in a battery system by way of which it is possible to perform a process that is both safe and reliable and may be easily automated for routing and contacting the cell voltage measuring lines.

In accordance with embodiments, a battery system may include at least one of: a plurality of cells that are arranged at least in one stack, a first pole of a first cell being connected in an electrically conductive manner to a second pole of a second cell by way of a cell connector; an electronic unit that is designed to detect the voltage of the cells; a first contacting element arranged on the cell connector and which includes a first opening; a second contacting element arranged on the electronic unit and which includes a second opening; and a conductor having a first section connected in an electrically conductive manner to the first contacting element and a second section connected in an electrically conductive manner to the second contacting element, wherein the conductor makes contact with the first contacting element and the second contacting element by way of first contact members arranged on the first contacting element and the second contacting element and which are designed to penetrate the insulation of the conductor at least in sections and deform the conductor at least in sections, wherein the conductor may be inserted into the first opening and the second opening to contact the first contacting element, and the first opening is designed so that the first section of the conductor may be inserted parallel to a base surface of the cell connector, and the second opening is designed so that the second section of the conductor may be inserted parallel to a base surface of the electronic unit.

In accordance with embodiments, by virtue of aligning the first opening and the second opening, it is possible for the first section of the conductor to make contact with the first contacting element parallel to the base surface of the cell connector, and for the second section of the conductor to make contact with the second contacting element parallel to the base surface of the electronic unit. The tool for providing the contacting arrangement may encompass the first/second contacting element during the contacting process in such a manner that the force that is required to produce the contacting arrangement is supported directly on the first/second contacting element. As a consequence, neither the cell connector and the cells that are connected thereto nor the electronic unit are subjected to mechanical loads. As a further consequence, damage or earlier damage to the cells or electronic unit is prevented.

In accordance with embodiments, the conductor may be embodied either as a solid conductor or from a plurality of litz wires. If the conductor is embodied from multiple litz wires and forms in this manner a litz wire conductor, then the apparent diameter of the litz wire conductor and also any litz wires that are in contact with the first contact members deform as the conductor makes contact with the first/second contacting element.

In accordance with embodiments, the electronic unit may be embodied as a printed circuit board (PCB) and consequently has a planar structure. The components that are fastened to the electronic unit are fastened at least to its base surface and are optionally fastened on the rear side that is opposite the base surface. The cell connector likewise has a planar structure and comprises a first section to which the first pole of the first cell is connected, a second section to which the second pole of the second cell is connected, and a connecting section that connects the first section to the second section. The first section and the second section of the cell connector may be arranged in a common plane and form the base surface of the cell connector. The connecting section may comprise regions that are raised from the base surface of the cell connector, by way of example, a mechanically flexible region having a load-relieving elevation or depression.

In accordance with embodiments, a method for producing an electrically conductive connection between a cell connector, which is connected to the poles of at least two cells of a battery system, and an electronic unit by way of a conductor, the method including at least one of: fastening a first contacting element to the cell connector; fastening a second contacting element to the electronic unit; inserting a first section of the conductor into a first auxiliary device of the first contacting element, wherein the insertion direction is perpendicular to the base surface of the cell connector; displacing the first auxiliary device parallel to the base surface of the cell connector towards the first contact members of the first contacting element; inserting a second section of the conductor in a second auxiliary device of the second contacting element, wherein the insertion direction is perpendicular to the base surface of the electronic unit; and displacing the second auxiliary device parallel to the base surface of the electronic unit towards the first contact members of the second contacting elements.

In accordance with embodiments, the process of introducing the conductor into the first/second auxiliary device perpendicular to the base surface of the cell connector/electronic unit facilitates the arrangement whereby the conductor is held during the method of producing the battery system. The reason for this is that the first/second contacting element together with the first/second auxiliary device is only a few millimetres high, by way of example, less than 5 mm. It would be difficult in the case of this small installation height to introduce the conductor from the side, i.e., in a plane parallel to the cell connector/electronic unit, towards the first/second opening since the contacting tool must encompass the conductor in order to hold the conductor. The free access to the cell connector/electronic unit required for this purpose by the contacting tool could only be ensured to a limited extent when introducing the conductor from the side. If the first/second section is inserted into the first/second auxiliary device, then the first/second auxiliary device is displaced sideward i.e. parallel to the base surface of the cell connector/electronic unit towards the corresponding first contact members of the first/second contacting element. This is preferably performed using the same contacting tool.

The sideward displacement of the first auxiliary device causes the first section of the conductor to make contact with the first contact members of the first contacting element, i.e., the insulation of the conductor is penetrated and the first section of the conductor is deformed, as a consequence of which a stable, electrically conductive connection is produced between the first section of the conductor and the first contacting element. The second section of the conductor makes contact with the second contacting element in a similar manner.

In accordance with embodiments, the first contacting element comprises an extension by way of which the first contacting element may be fastened to the cell connector, by way of example, by being pressed into the cell connector. As an alternative thereto, the first contacting element comprises a suitable contact site where it is possible to produce an ultrasound contacting arrangement between the first contacting element and the cell connector.

In accordance with embodiments, the second contacting element likewise comprises an extension by way of which the second contacting element may be fastened to the electronic unit, by way of example, by being pressed into the electronic unit. As an alternative thereto, the second contacting element may be fastened to the electronic unit using a soldering method, by way of example, using the reflow method.

In accordance with embodiments, a first auxiliary device may be arranged on the first contacting element and a second auxiliary device may be arranged on the second contacting element. The first auxiliary device comprises a first receiving section into which the first section of the conductor in the non-contacted state may be inserted perpendicular to the base surface of the cell connector. The second auxiliary device comprises a second receiving section into which the second section of the conductor in the non-contacted state may be inserted perpendicular to the base surface of the electronic unit. In the non-contacted state, the first/second section of the conductor is not connected to the first/second contacting element. This state occurs during the process of assembling the battery system. By virtue of the fact that the first/second receiving section is aligned with the first/second auxiliary device it is possible to perform an automated process of introducing the conductor into the first/second auxiliary device since the conductor may be encompassed in this manner by a corresponding contacting tool without having to provide the necessary free access for the tool to the cell connector/electronic unit.

In accordance with embodiments, the first auxiliary device in the non-contacted state of the first contacting element is arranged so as to cover the first opening at least in part. The second auxiliary device in the non-contacted state of the second contacting element is arranged so as to cover the second opening at least in part. As a consequence, the first/second section of the conductor is prevented from coming into unintentional contact with the first contact members of the first/second contacting elements during the assembly process. This prevents the conductor being damaged during the insertion process prior to contacting the first contact member.

In accordance with embodiments, the first auxiliary device is designed for contacting purposes so as to be displaceable parallel to the base surface of the cell connector towards the first contact members of the first contacting element. The second auxiliary device is designed for contacting purposes so as to be displaceable parallel to the base surface of the electronic unit towards the first contact members of the second contacting elements. The first contacting element and the second contacting element and also the first auxiliary device and the second auxiliary device comprise for this purpose suitable guides or rails and also optional stops so that the first/second auxiliary device cannot become unintentionally detached from the first/second contacting element.

In accordance with embodiments, the stack of cells may be arranged in such a manner that the poles of the cells form two rows, in which the electronic unit may be arranged between these rows. As a consequence, the electronic unit may be arranged in a particularly space-saving manner, in which the entire external dimensions of the battery system are reduced.

In accordance with embodiments, the electronic unit may be fastened to a holding plate that is arranged on the at least one stack of cells. The holding plate may protrude beyond the two rows, and may also accommodate and hold the cell connectors.

In accordance with embodiments, the conductor may extend in a straight line from the first contacting element to the second contacting element until it achieves height compensation and length compensation. The first contacting element may be arranged in immediate proximity, i.e., within a few centimetres, of the second contacting element. As a consequence, the conductor extends in a straight line, i.e., without deflecting, between a first contacting element and a second contacting element. A height compensation and a length compensation, however, may be provided in order to avoid the conductor being subjected to a tensile load and also for the purpose of compensating tolerances in the position between the first and the second contacting element. The free length of the conductor between the first contacting element and the second contacting element is therefore selected so that differences in the height and distance are compensated for.

In accordance with embodiments, at least one extension may be formed on the holding plate and the extension is designed for the purpose of deflecting the run of the conductor from the first contacting element to the second contacting element. Particularly, in the case of a stack that comprises a large number of cells, the electronic unit does not extend along the entire stack length. Long electronic units of this type are not common and are often not available since the equipment for manufacturing electronic units, such as for example, a solder furnace, is not suitable for receiving long electronic units of this type. A combination of multiple electronic units, however, means greater outlay with respect to the connecting technology between these electronic units. It is therefore advantageous to deflect the conductor particularly for any conductors that are connected to a first contacting element and are arranged remotely from the electronic unit in the stack.

In accordance with embodiments, the base surface of the electronic unit may be parallel to the base surface of the cell connector. The base surface of the electronic unit may be arranged in the same plane as the base surface of the cell connector. This facilitates the automated production of the battery system since the contacting tool only needs to move in one plane.

In accordance with embodiments, the first and/or the second contacting element comprises second contact members that are designed so as in the contacted state to clamp a section of the conductor on its insulation.

In accordance with embodiments, the insulation of a section of the conductor may be clamped between the first auxiliary device and the second contact members by way of displacing the first auxiliary device. Likewise, the insulation of a section of the conductor may be clamped between the second auxiliary device and the second contact members by virtue of the fact that the first auxiliary device is displaced. The second contact members may be used to relieve the load on the first/second section of the conductor. By virtue of relieving the load, it is possible to considerably enhance the durability of the connection between the first/second section of the conductor and the first/second contacting element.

The second contact members may be arranged in such a manner that they relieve the tensile load that is exerted on the first/second section of the conductor in the first contact members. As a result, the second contact members of the first contacting element are located further away than the first contact members of the first contacting element from that end of the conductor on which the first section of the conductor is located. Similarly thereto, the second contact members of the second contacting element are located further away than the first contact members of the second contacting element from that end of the conductor on which the second section of the conductor is located. The second contact members are accordingly located in the run of the conductor within the first contact members.

In accordance with embodiments, a battery system may include at least one of: a plurality of cells arranged in at least one stack; a cell connector to connect a first pole of a first cell in an electrically conductive manner to a second pole of a second cell; an electronic unit to detect the voltage of the cells; a first contacting element arranged on the cell connector and which includes a first opening; a second contacting element arranged on the electronic unit and which includes a second opening; a conductor having a first conductor section connected in an electrically conductive manner to the first contacting element and a second conductor section connected in an electrically conductive manner to the second contacting element; first contact members arranged on the first contacting element and the second contacting element to establish contact between the conductor, the first contacting element and the second contacting element, wherein: the first contact members are to at least one of penetrate insulation of the conductor at least in sections, and deform the conductor at least in sections, the conductor is configured for insertion into the first opening and the second opening to establish contact with the first contact members; the first opening is configured to permit insertion of the first conductor section parallel to a base surface of the cell connector; and the second opening is configured to permit insertion of the second conductor section parallel to a base surface of the electronic unit.

In accordance with embodiments, a method for producing an electrically conductive connection between a cell connector connected to poles of at least two cells of a battery system, and an electronic unit by way of a conductor, may include at least one of: fastening a first contacting element to the cell connector; fastening a second contacting element to the electronic unit; inserting a first section of the conductor into a first auxiliary device of the first contacting element, wherein the insertion direction is perpendicular to a base surface of the cell connector; displacing the first auxiliary device parallel to the base surface of the cell connector towards the first contact members of the first contacting element; inserting a second section of the conductor in a second auxiliary device of the second contacting element, wherein the insertion direction is perpendicular to a base surface of the electronic unit; and displacing the second auxiliary device parallel to the base surface of the electronic unit towards the first contact members of the second contacting elements.

### DRAWINGS

Embodiments will be illustrated by way of example in the drawings and explained in the description below.

FIG. 1 illustrates a schematic view of a battery system, in accordance with embodiments.

FIG. 2 illustrates a side view of a first/second contacting element, in accordance with embodiments.

FIG. 3 illustrates a side view of the first/second contacting element with a first/second auxiliary device in a non-contacted state, in accordance with embodiments.

FIG. 4 illustrates a side view of the first/second contacting element with a first/second auxiliary device and a first/second section of the conductor that is inserted in the first/second auxiliary device in the non-contacted state, in accordance with embodiments.

FIG. 5 illustrates a side view of the first/second contacting element together with a first/second auxiliary device in the contacted state, in accordance with embodiments.

FIG. 6 illustrates a schematic view of the first/second contacting element with first and second contact members, in accordance with embodiments.

### DESCRIPTION

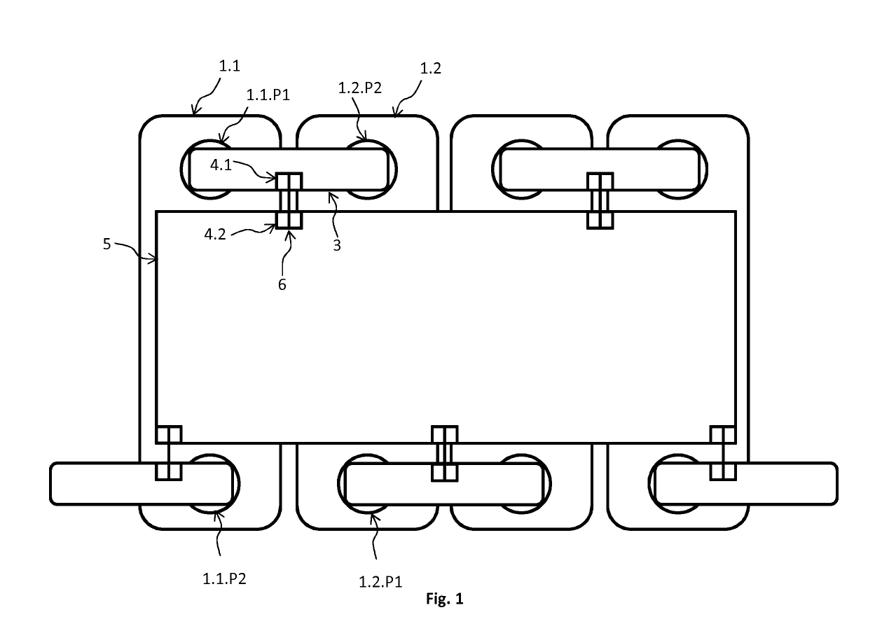

FIG. 1 illustrates a schematic plan view of a battery system in accordance with the invention. A plurality of cells 1.1, 1.2 is arranged in a stack, so that the poles 1.1.P1, 1.1.P2, 1.2.P1, 1.2.P2 of the cells 1.1, 1.2 form two rows. A first pole 1.1.P1 of a first cell 1.1 is connected in an electrically conductive manner to a second pole 1.2.P2 of a second cell 1.2 by way of a cell connector 3. An electronic unit 5 is arranged between the two rows of poles 1.1.P1, 1.1.P2, 1.2.P1, 1.2.P2. A first contacting element 4.1 is arranged on the cell connector 3. The first contacting element 4.1 is fixedly connected in a suitable manner in an electrically conductive and mechanical manner to the cell connector 3. By way of example, the first contacting element 4.1 is pressed into the cell connector 3 or is soldered or welded thereto.

The electronic unit 5 comprises a plurality of second contacting elements 4.2. Each second contacting element 4.2 is connected in an electrically conductive manner to a conductor track of the electronic unit 5, by way of example, by way of a solder connection or a plug-in connection. Each second contacting element 4.2 is connected in an electrically conductive manner in each case to a first contacting element 4.1 by way of a conductor 6. The electronic unit 5 is designed so as to detect and evaluate the voltage of the cells 1.1, 1.2. The voltage of the cells 1.1, 1.2 is transmitted to the electronic unit 5 by way of the cell connector 3, the first contacting element 4.1, the conductor 6 and the second contacting element 4.2.

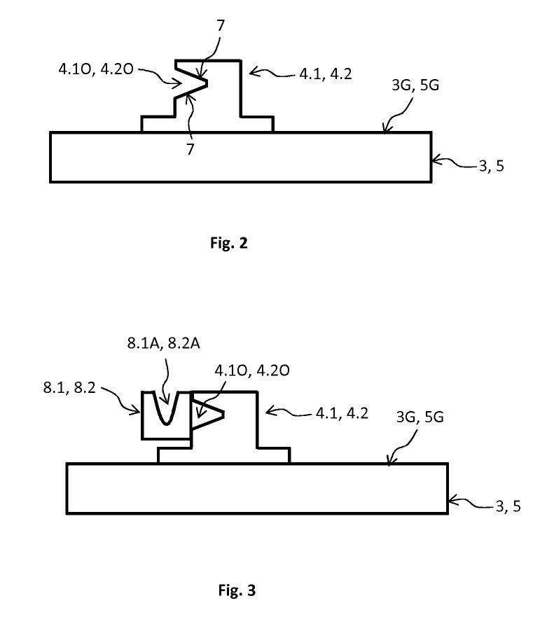

FIG. 2 illustrates a schematic side view of the first/second contacting element 4.1/4.2. The first and the second contacting element 4.1, 4.2 are constructed in an essentially identical manner, and differ merely by virtue of their mechanical and electrical connection to the cell connector 3 or the electronic unit 5. The first contacting element 4.1 is arranged on a base surface 3G of the cell connector 3, whereas the second contacting element 4.2 is arranged on a base surface 5G of the electronic unit 5. The first/second contacting element 4.1, 4.2 comprises first contact members 7 that are designed so as to penetrate the insulation of the conductor 6 at least in sections and to deform the conductor 6 at least in sections. The first contact members 7 may by way of example be embodied from blades that together form a cutting clamp. As an alternative thereto, the first contact members 7 may also be embodied as piercing tips.

The first contacting element 4.1 comprises a first opening 4.1O. The first opening 4.1O is arranged so that a first section 6.1 of the conductor 6 may be inserted into the first opening 4.1O in a plane parallel to the base surface 3G of the cell connector 3. The second contacting element 4.2 comprises a second opening 4.2O. The second opening 4.2O is arranged so that a second section 6.2 of the conductor 6 may be inserted into the second opening 4.2O in a plane parallel to the base surface 5G of the cell connector 5.

FIG. 3 illustrates a schematic side view of the first/second contacting element 4.1/4.2 with a first/second auxiliary device 8.1/8.2 in the non-contacted state. The first auxiliary device 8.1 is arranged in this state so as to cover the first opening 4.1O at least in part. The first auxiliary device 8.1 comprises a first receiving section 8.1A having an open cross section. Also, the second auxiliary device 8.2 in the non-contacted state is arranged so as to cover the second opening 4.2O at least in part. The second auxiliary device 8.2 comprises a second receiving section 8.2A having an open cross section.

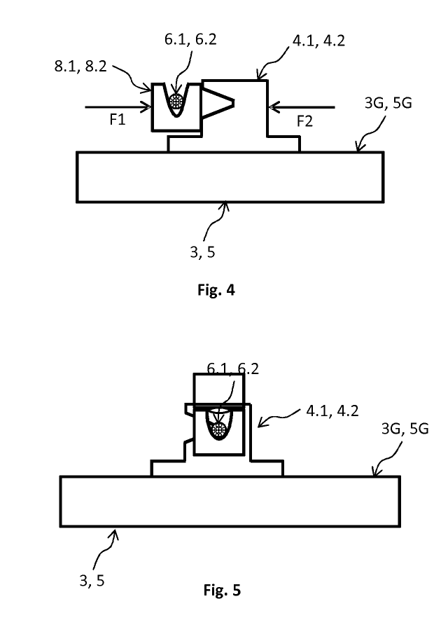

FIG. 4 illustrates a schematic side view of the first/second contacting element 4.1/4.2 with a first/second auxiliary device 8.1/8.2 in the non-contacted state, and a first/second section 6.1/6.2 of the conductor 6 that is inserted in the first/second auxiliary device 8.1/8.2. The first section 6.1 of the conductor 6 is inserted into the first receiving section 8.1A, wherein the first section 6.1 of the conductor 6 may be inserted perpendicular to the base surface 3G of the cell connector 3. The second section 6.2 of the conductor 6 is inserted into the second receiving section 8.2A, wherein the second section 6.2 of the conductor 6 may be inserted perpendicular to the base surface 5G of the cell connector 5.

The first auxiliary device 8.1 may be displaced parallel to the base surface 3G of the cell connector 3 towards the first contact members 7 of the first contacting element 4.1. In so doing, a force is exerted along a first force direction F1 on the first auxiliary device 8.1. In order to support the first contacting element 4.1, a force is likewise exerted along a second force direction F2 on that side of the first contacting element 4.1 that is opposite the first opening 4.1O. In this manner, the first auxiliary device 8.1 is displaced towards the first contact members 7 of the first contacting element 4.1, wherein the first section 6.1 of the conductor 6 is contacted by the first contact members 7, and thus the insulation of the first section 6.1 of the conductor 6 is penetrated and the first section 6.1 of the conductor 6 is deformed by the first contact member 7. The forces are applied by way of a contacting tool, not illustrated. The first and the second force direction F1, F2 are parallel to the base surface 3G of the cell connector 3.

The second auxiliary device 8.2 may be displaced parallel to the base surface 5G of the electronic unit 5 towards the first contact members 7 of the second contacting element 4.2. In so doing, a force is exerted along a first force direction F1 on the second auxiliary device 8.2. In order to support the second contacting element 4.2, a force is likewise exerted along a second force direction F2 on that side of the first contacting element 4.2 that is opposite the second opening 4.2O. In this manner, the second auxiliary device 8.2 is displaced towards the first contact members 7 of the second contacting element 4.2, wherein the second section 6.2 of the conductor 6 is contacted by the first contact members 7, and thus the insulation of the second section 6.2 of the conductor 6 is penetrated and the second section 6.2 of the conductor 6 is deformed by the first contact member 7. The forces are applied by way of a contacting tool, not illustrated. The first and the second force direction F1, F2 are parallel to the base surface 5G of the electronic unit 5.

FIG. 5 illustrates a schematic side view of the first/second contacting element 4.1/4.2 together with a first/second auxiliary device 8.1/8.2 in the contacted state.

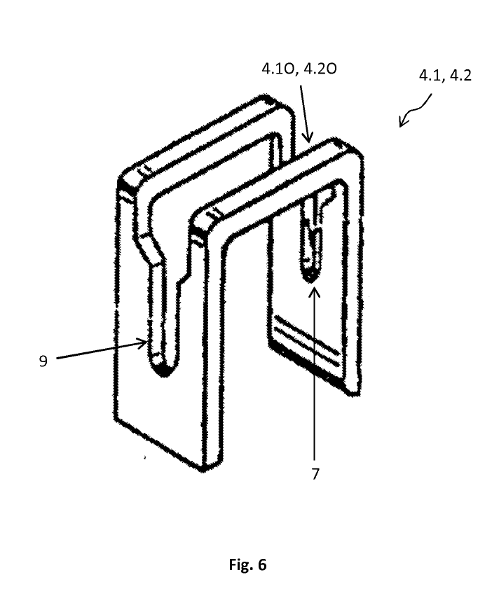

FIG. 6 illustrates a schematic view of the first/second contacting element 4.1/4.2 with first contact members 7 and second contact members 9. The first/second auxiliary device 8.1/8.2 is not illustrated. Whereas the first contact members 7 are embodied by way of example as blades, the second contact members 9 are designed merely so as to clamp the insulation of a section of the conductor 6. Accordingly, the second contact members do not form blades or any other devices for penetrating the insulation of the conductor 6, but rather merely comprise a blunt contact surface into which the cross section of the conductor 6 together with its insulation directly passes, and thus lies against the contact surfaces of the second contact members 9.

The term “coupled” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SIGNS

1.1 First Cell
1.2 Second Cell
1.1.P1 First Pole of the First Cell
1.1.P2 Second Pole of the First Cell
1.2.P1 First Pole of the Second Cell
1.2.P2 Second Pole of the Second Cell
3 Cell Connector
3G Base Surface of the Cell Connector
4.1 First Contacting Element
4.1O First Opening
4.2 Second Contacting Element
4.2O Second Opening
5 Electronic Unit
5G Base surface of the Electronic Unit
6 Conductor
6.1 First Section of the Conductor
6.2 Second Section of the Conductor
7 First Contact Member
8.1 First Auxiliary Device
8.1A First Receiving Section
8.2 Second Auxiliary Device
8.2A Second Receiving Section
9 Second Contact Member
F1 First Force Direction
F2 Second Force Direction

What is claimed is:

1. A battery system, comprising:
a plurality of cells arranged in at least one stack,
a cell connector to connect a first pole of a first cell in an electrically conductive manner to a second pole of a second cell;
an electronic unit to detect the voltage of the cells;
a first contacting element arranged on the cell connector and which includes a first opening;
a second contacting element arranged on the electronic unit and which includes a second opening;
a conductor having a first conductor section connected in an electrically conductive manner to the first contacting element and a second conductor section connected in an electrically conductive manner to the second contacting element,
first contact members arranged on the first contacting element and the second contacting element to establish contact between the conductor, the first contacting element and the second contacting element,
wherein:
the first contact members are to at least one of penetrate insulation of the conductor at least in sections, and deform the conductor at least in sections
the conductor is configured for insertion into the first opening and the second opening to establish contact with the first contact members;
the first opening is configured to permit insertion of the first conductor section parallel to a base surface of the cell connector; and
the second opening is configured to permit insertion of the second conductor section parallel to a base surface of the electronic unit.

2. The battery system of claim 1, further comprising a first auxiliary device arranged on the first contacting element, the first auxiliary device having a first receiving section into which the first conductor section, in a non-contacted state, may be inserted perpendicular to the base surface of the cell connector.

3. The battery system of claim 2, further comprising a second auxiliary device arranged on the second contacting element, the second auxiliary device having a second receiving section into which the second conductor section, in a non-contacted state, may be inserted perpendicular to the base surface of the electronic unit.

4. The battery system of claim 3, wherein the first auxiliary device, in the non-contacted state of the first contacting element, is arranged to at least partially cover the first opening.

5. The battery system of claim 4, wherein the second auxiliary device, in the non-contacted state of the second contacting element is arranged so as to cover the second opening at least in part.

6. The battery system of claim 3, wherein the first auxiliary device is configured, for contacting purposes, to be displaceable parallel to the base surface of the cell connector towards the first contact members of the first contacting element.

7. The battery system of claim 6, wherein the second auxiliary device is configured, for contacting purposes, to be displaceable parallel to the base surface of the electronic unit towards the first contact members of the second contacting element.

8. The battery system of claim 1, wherein the stack of cells is arranged so that poles of the cells form two rows.

9. The battery system of claim 8, wherein the electronic unit is arranged between the TOWS.

10. The battery system of claim 1, further comprising a holding plate to which is fastened the electronic unit and on which is arranged at least one stack of the cells.

11. The battery system of claim 10, further comprising at least one extension formed on the holding plate to deflect a run of the conductor from the first contacting element to the second contacting element.

12. The battery system of claim 1, wherein the conductor extends in a straight line from the first contacting element to the second contacting element until achieving height compensation and length compensation.

13. The battery system of claim 1, wherein the base surface of the electronic unit is parallel to the base surface of the cell connector.

14. The battery system of claim 1, wherein the base surface of the electronic unit is arranged in a same plane as the base surface of the cell connector.

15. The battery system of claim 1, wherein the first contacting element comprises second contact members configured to, in the contacted state, clamp a section of the conductor at an insulation of the conductor.

16. The battery system of claim 1, wherein the second contacting element comprises second contact members configured to, in the contacted state, clamp a section of the conductor at an insulation of the conductor.

17. A method for producing an electrically conductive connection between a cell connector connected to poles of at least two cells of a battery system, and an electronic unit by way of a conductor, the method comprising:
fastening a first contacting element to the cell connector;
fastening a second contacting element to the electronic unit;
inserting a first section of the conductor into a first auxiliary device of the first contacting element, wherein the insertion direction is perpendicular to a base surface of the cell connector;
displacing the first auxiliary device parallel to the base surface of the cell connector towards the first contact members of the first contacting element;
inserting a second section of the conductor in a second auxiliary device of the second contacting element, wherein the insertion direction is perpendicular to a base surface of the electronic unit; and
displacing the second auxiliary device parallel to the base surface of the electronic unit towards the first contact members of the second contacting elements.

18. The method of claim 17, wherein the first contacting element comprises second contact members, and by virtue of displacing the first auxiliary device, insulation of a section of the conductor is clamped between the first auxiliary device and the second contact members.

19. The method of claim 17, wherein the second contacting element comprises second contact members, and by virtue of displacing the second auxiliary device the insulation of a section of the conductor is clamped between the second auxiliary device and the second contact members.
